(19) United States
(12) Patent Application Publication
(10) Pub. No.: US 2026/0299953 A1
(43) Pub. Date: Oct. 1, 2026

(54) METHOD AND SYSTEM FOR ANALYZING A COMPUTER PROGRAM

(71) Applicant: SIEMENS INDUSTRY SOFTWARE INC., Plano, TX (US)

(72) Inventor: Marcel Zak, Cambridge (GB)

(21) Appl. No.: 19/478,829

(22) PCT Filed: Apr. 26, 2023
(86) PCT No.: PCT/US2023/020020

§ 371 Date: Oct. 26, 2025

(51) Int. Cl. G06F 9/32; G06F 9/30

(52) U.S. Cl. CPC G06F 9/321; G06F 9/30047

(57) ABSTRACT

A method for inferring a program counter of a program executed by a computing system is provided. The method includes identifying, based on a program counter value including an address of a sequential instruction in the program, a sequential execution path containing the sequential instruction. The method also includes inferring a further program counter value based on the identified sequential execution path. The further program counter value includes an address of a last sequential instruction in the identified sequential execution path.

This application is the National Stage of International Application No. PCT/US2023/020020, filed Apr. 26, 2023. The entire contents of this document are hereby incorporated herein by reference.

### TECHNICAL FIELD

The present disclosure relates to methods and systems for analyzing computer program behavior. In particular, methods and systems are provided for inferring a program counter of a computer program executed on a computing system.

### BACKGROUND

Modern computing systems frequently execute highly complex software programs including millions or billions of individual instructions. During normal execution, a program will either step from one instruction to the next in the order the instructions are stored in the memory, or non-sequentially from one instruction to another instruction that does not immediately follow the original instruction. The computing system keeps track of which instruction is being executed using a program counter. The program counter is incremented to point to the next instruction once the current instruction has been fetched from memory.

It is possible to reconstruct the program flow of a program executed by a processor using a trace. A trace may be used to assist in program debugging or monitoring operations. In one arrangement, a trace interface may be used to output relevant information from the processor for tracking operations, and a hardware encoder may be provided to receive the data from the trace interface. The hardware encoder compresses the data for transmission off-chip via a communication channel such as a USB connection. A decoder that may be provided as software on an external computer takes the trace packets and, with knowledge of the program binary, reconstructs the program counter values. This enables the decoder to restore the state of the computing system during program execution. These decoding operations may be performed offline or online in real time.

Modern processors run at high clock speeds. This provides that a very large number of instructions are executed in a short space of time. Consequently, the amount of data output from the trace interface grows rapidly. Transmitting data for every single operation becomes unmanageable as the amount of data exceeds the available bandwidth. Instruction delta tracing, also known as branch tracing, is a method that may be used to reduce the volume of data being sent by the trace encoder. A delta is a change in the program counter as a result of the execution of a non-sequential instruction. Deltas are introduced by jump, call, return, and branch type instructions, as well as interrupts and exceptions.

In instruction set architectures where every instruction is executed unconditionally, such as RISC-V, instructions between deltas may be assumed to have been executed sequentially. There is no need to send data in a trace for these instructions since the decoder may simply assume that all the sequential instructions were executed until the next non-sequential instruction. The decoder is able to reconstruct the full execution path with only the deltas and the program binary, since the program counter is fully determined from information available to the decoder.

### SUMMARY

The scope of the present invention is defined solely by the appended claims and is not affected to any degree by the statements within this summary.

The present embodiments may obviate one or more of the drawbacks or limitations in the related art. For example, a method for inferring a program counter value for a program executed by a computing system is provided.

The foregoing and other objects are achieved by the features of the independent claims. Further implementation forms are apparent from the dependent claims, the description, and the figures.

According to a first aspect of the present embodiments, a method for inferring a program counter of a program executed by a computing system is provided. The method includes identifying, based on a program counter value including an address of a sequential instruction in the program, a sequential execution path containing the sequential instruction. The method also includes inferring a further program counter value based on the identified sequential execution path. The further program counter value corresponds to an address of the last sequential instruction in the identified sequential execution path.

The method according to the first aspect improves an efficiency of decoding by inferring the program counter based on an identification of a sequential code path. Inferring the program counter value by identifying the sequential code path containing the initial program counter value removes the need to iterate over every sequential instruction in a sequential path, and allows the decoder to jump straight to the last sequential instruction in the path.

In a first implementation form of the method according to the first aspect, the sequential execution path is identified based on a decompiled binary of the program.

In a second implementation form of the method according to the first aspect, the sequential execution path is identified during run-time.

In a third implementation form of the method according to the first aspect, inferring the further program counter value includes storing an address of the last sequential instruction in the identified sequential execution path and determining the further program counter value based on the address of the last sequential instruction in the identified sequential execution path.

In a fourth implementation form of the method according to the first aspect, the method includes determining a program counter value based on trace data obtained from the computing system during execution of the program.

In a fifth implementation form of the method according to the first aspect, identifying a sequential execution path includes accessing a data cache including a mapping of sequential instruction addresses to sequential execution paths and applying the mapping to the program counter value to identify the sequential execution path containing the sequential instruction corresponding to the program counter value.

In a sixth implementation form of the method according to the first aspect, the method includes restoring a state of the computing system during program execution based on the program counter.

According to a second aspect of the present embodiments, a method for analyzing a decompiled binary of a program is provided. The method according to the second aspect includes determining, for each instruction in the decompiled binary, whether the instruction is a sequential instruction, and, when the instruction is a sequential instruction, adding the address of the instruction to a list of addresses of sequential instructions. The method includes determining whether the list includes at least three addresses and storing the list in a data cache of sequential execution paths, when the list of addresses includes at least three addresses.

The method according to the second aspect enables the construction of a sequential path cache that may be used in conjunction with the method according to the first aspect to improve the efficiency of decoding methods.

In a first implementation form of the method according to the second aspect, the method includes, when the instruction is a non-sequential instruction, determining whether the instruction is a branch instruction, an inferable jump instruction, or a sequentially inferable jump instruction.

In a second implementation form of the method according to the second aspect, the method includes adding a branch label address to a further list when the instruction is a branch instruction. The further list includes addresses of initial instructions of potential sequential execution paths.

In a third implementation form of the method according to the second aspect, the method includes adding a jump address to the further list when the instruction is an inferable jump instruction or a sequentially inferable jump instruction.

In a fourth implementation form of the method according to the second aspect, the method includes identifying a start address of the potential sequential execution path from an ordered list of instruction from the decompiled binary and determining whether there is a sequential path including at least three sequential instructions.

According to a third aspect of the present embodiments, an apparatus for monitoring the program flow of a program executed by a computing system is provided. The apparatus is configured to identify, based on a program counter value including an address of a sequential instruction in the program, a sequential execution path containing the sequential instruction and infer a further program counter value based on the identified sequential execution path. The further program counter value corresponds to an address of the last sequential instruction in the identified sequential execution path.

In a first implementation form of the apparatus according to the third aspect, the apparatus further includes a data cache configured to store a mapping of sequential instruction addresses to sequential execution paths.

In a second implementation form of the apparatus according to the third aspect, the apparatus is configured to access the data cache, and apply the mapping to the first program counter value to identify the sequential execution path containing the instruction.

These and other aspects of the invention will be apparent from the embodiments described below.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a flow diagram of a method for inferring a program counter value, according to an example;

FIG. 2 shows a flow diagram of a method for analyzing a decompiled binary of a program, according to an example;

FIG. 3 shows a flow diagram of a method for analyzing a decompiled binary of a program, according to an example; and

FIG. 4 shows a simplified schematic diagram of a computing system, according to an example.

### DETAILED DESCRIPTION

Example embodiments are described below in sufficient detail to enable those of ordinary skill in the art to embody and implement systems and processes described herein. Embodiments may be provided in many alternate forms and should not be construed as limited to the examples set forth herein.

Accordingly, while embodiments may be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that the articles have a single referent; however, the use of the singular form in the present document should not preclude the presence of more than one referent. In other words, elements referred to in the singular may number one or more, unless the context clearly indicates otherwise. It will be further understood that the terms “comprises,” “comprising,” “includes,” “including,” “contains,” and/or “containing” when used herein, specify the presence of stated features, items, steps, operations, elements, and/or components, but do not preclude the presence or addition of one or more other features, items, steps, operations, elements, components, and/or groups thereof.

Unless otherwise defined, all terms including technical and scientific terms used herein are to be interpreted as is customary in the art. Terms in common usage should also be interpreted as is customary in the relevant art and not in an idealized or overly formal sense unless expressly so defined herein.

Instruction delta tracing successfully reduces an amount of data that is to be communicated to a decoder. Unfortunately, the decoder is still to follow sequential instructions to fully reconstruct program counter (PC) addresses. A next address is determined from a sum of a current address and a size of the instruction, and the decoder does not know the size of a next sequential instruction nor how many sequential instructions there are in front of the current instruction before encountering a branch or a jump.

Further, a majority of instructions are sequential. For example, a program that multiplies two arrays and stores a result in a third array may include 20 sequential instructions and one branch to check if the program has arrived at an end of the array. If the array length is only 100 elements, then the decoder will have to fetch and iterate over 2000 sequential instructions and only 100 branch instructions. In the decoding process, the decoder therefore spends a majority of its time iterating over sequential instructions.

The methods and systems described herein improve an efficiency of the decoder by removing the need to iterate over sequential code paths. This is achieved using a data cache that enables the decoder to quickly identify a start address of sequential code paths. The data cache is constructed in two stages based on analysis of a decompiled binary of the program.

In a first stage, each instruction is evaluated to determine if the instruction is sequential or, if non-sequential, whether the instruction is a branch, inferable jump, or a sequentially inferable jump. An inferable jump instruction is a jump instruction where a target address is supplied via a constant embedded within a jump opcode. A sequentially inferable jump is a jump that may be inferred from the binary by considering pairs of instructions, for example, where the jump target is supplied via a register that contains a constant. Any sequential code paths of length greater than two are added to the data cache. For each branch, inferable jump, or sequentially inferable jump instruction, an address is added to a list of potential sequential paths.

In a second stage, each potential sequential path is analyzed in a similar fashion to the paths in stage one. The start address of each potential sequential path is identified from an ordered list of instructions from the program binary. If a sequential code path having length greater than two is identified, then the path is also saved to the data cache.

In a decoding stage, a mapping of sequential addresses to sequential code paths in the data cache is used to infer a program counter. When the decoder arrives at a certain program counter address, the decoder may check the data cache to determine whether there is a sequential path having the current address pointed to by the program counter as a start address. If there is a path, then the decoder may reconstruct a state of a computing system at an end of the sequential path by setting the program counter to be a last program counter value in the identified sequential path. Herein, references to the last instruction in a sequential execution path refer to the last sequential instruction at the end of a sequential execution path.

The decoder knows the next instruction is a non-sequential instruction because the previous address was the last sequential address in a sequential path. The decoder may therefore determine the next address from a next delta received from a trace to obtain the address of the next instruction. Thus, the decoder has avoided having to iterate through the entire sequential path and may jump to a last address in the path directly, with the knowledge that every instruction between the start address and previous address was executed by the processor. The decoder may still output a correct program counter value for every instruction, as the whole sequential path is known from the cache.

In some cases, the decoder may also make use of cached sequential execution paths even where, for example, there is an interrupt between two sequential instructions in the sequential path during code execution. For example, in the case of a loop including a sequence of sequential instructions followed by a branch instruction, the decoder may still use the cached path if there are some unprocessed branches. Only after there are no more branches, then it must jump into the correct place in the cached sequential path and set the decoder to the correct state.

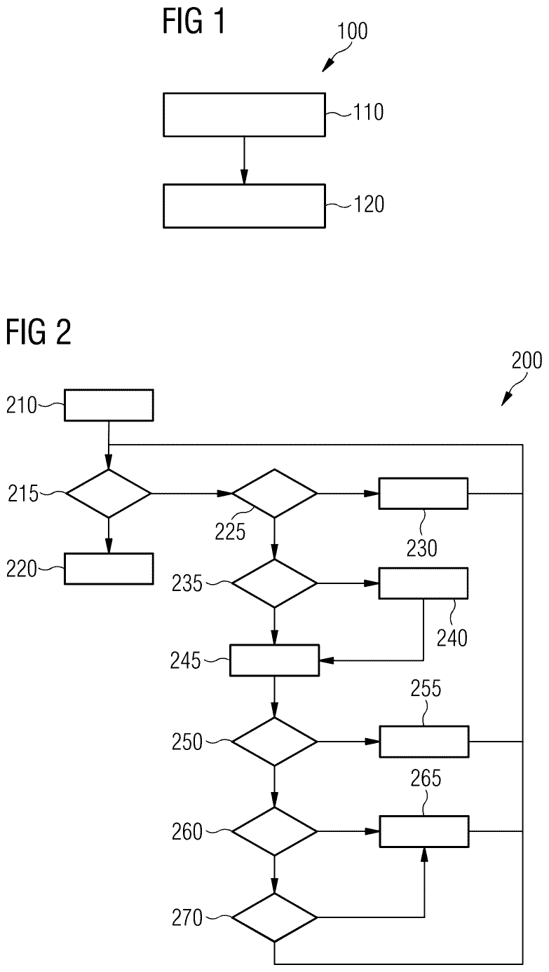

FIG. 1 is a flow diagram showing a method 100 for inferring a program counter of a program executed by a computing system, according to an example. The method 100 may be used in conjunction with other methods and systems described herein. For example, the method 100 may be used by a decoder as previously described to restore a state of the computing system during program execution.

At block 110, the method 100 includes identifying, based on a program counter value including an address of a sequential instruction in the program, a sequential execution path containing the sequential instruction. According to examples, identifying a sequential execution path containing the instruction includes accessing a data cache including a mapping of sequential instruction addresses to one or more sequential execution paths and applying the mapping to the first program counter value to identify the sequential execution path containing the instruction. In some cases, the mapping may include a hash map of addresses of the first instruction in a potential sequential execution path to the potential sequential execution paths.

At block 120, the method 100 includes inferring a further program counter value based on the identified sequential execution path. The further program counter value includes an address of the last instruction in the identified sequential execution path. According to examples, inferring the further program counter value includes storing an address of the last instruction in the identified sequential execution path and determining the further program counter value based on the address of the last instruction in the identified sequential execution path. The address may be stored, for example, in a sequential path data cache as previously described. Determining the further program counter value may include adding the size of the instruction onto the stored address.

In some cases, the method 100 may include determining a program counter value based on data obtained from the computing system during execution of the program. The data may be trace data obtained from the computing system during execution and may include data indicating, for example, which branch a program took.

FIG. 2 is a flow diagram 200 showing a method of constructing a data cache of sequential paths, according to an example. At block 210, the method 200 includes accessing the decompiled binary of a program. At block 215, the method 200 includes determining whether there are more instructions to analyze in the binary. If there are no more instructions, then the method ends at block 220. Otherwise, at block 225, the method 200 includes determining whether the instruction is a sequential instruction. If the instruction is a sequential instruction, then at block 230, the instruction is added to a list including a current sequential path, and the method 200 returns to block 215. Otherwise, at block 235, a determination is made if the current sequential path is of length greater than two. If the current sequential path is of length greater than two, then at block 240, the current sequential path is saved to the data cache. If the current path is not of length greater than two, or after the current path has been saved to the data cache, then, at block 245, the current path is reset.

At block 250, the method 200 includes determining whether the instruction is a branch instruction. If the instruction is a branch instruction, then, at block 255, the branch label address is added to a new list, including potential sequential paths, and the method 200 returns to block 215.

Otherwise, at block 260, a determination is made whether the instruction is an inferable jump instruction. If the instruction is an inferable jump instruction, then, at block 265, the jump address of the instruction is added to the list of potential sequential paths, and the method 200 returns to block 215.

Otherwise, at block 270, the method 200 includes determining whether the instruction is a sequential inferable jump instruction. If the instruction is a sequential inferable jump instruction, then the jump address of the instruction is added to the list of potential sequential paths at block 265. The method 200 then returns to block 215 to evaluate the next instruction.

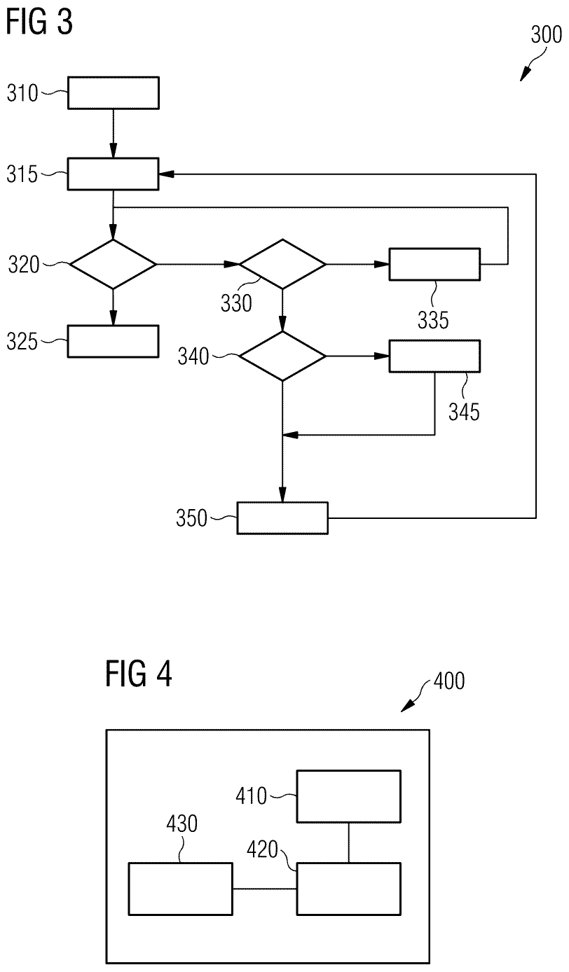

FIG. 3 is a flow diagram 300 showing a method of constructing a data cache of sequential paths, according to an example. The method 300 may be used in conjunction with the method 200. At block 310, the method 300 includes accessing a list of potential sequential path. The list of potential sequential paths may be constructed using the method 200 shown in FIG. 2.

At block 315, the method 300 includes identifying a start address of a potential sequential path in an ordered list of instructions from the decompiled binary of the program. At block 320, the method 300 includes determining whether there are more instructions to analyze in the binary. If there are no more instructions, then the method ends at block 325.

Otherwise, at block 330, the method 300 includes determining whether the instruction is a sequential instruction. If the instruction is a sequential instruction, then, at block 335, the instruction is added to a list including a current sequential path, and the method 300 returns to block 320. Otherwise, at block 340, a determination is made if the current sequential path is of length greater than two. If the current sequential path is of length greater than two, then, at block 345, the current sequential path is saved to the data cache. If the current path is not of length greater than two, or after the current path has been saved to the data cache, then, at block 350, the current path is reset. The method 300 then returns to block 315 to identify the start address of the next potential sequential path in the ordered list of instructions.

The present disclosure is described with reference to flow charts and/or block diagrams of the method, devices, and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added.

Each flow and/or block in the flow charts and/or block diagrams, as well as combinations of the flows and/or diagrams in the flow charts and/or block diagrams, may be realized by machine readable instructions.

The machine-readable instructions may, for example, be executed by a general-purpose computer, a special purpose computer, an embedded processor, or processors of other programmable data processing devices to realize the functions described in the description and diagrams. For example, a processor or processing apparatus may execute the machine-readable instructions. Thus, modules of the apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set, etc. The methods and modules may all be performed by a single processor or divided amongst a number of processors.

Such machine-readable instructions may also be stored in a computer readable storage that may guide the computer or other programmable data processing devices to operate in a specific mode. FIG. 4 shows an example 400 of a processor 410 associated with a memory 420. The memory 420 includes computer readable instructions 430 that are executable by the processor 410.

The instructions 430 cause the processor 410 to identify, based on a program counter value including an address of a sequential instruction in the program, a sequential execution path containing the sequential instruction and to infer a further program counter value based on the identified sequential execution path. The further program counter value includes an address of the last sequential instruction in the identified sequential execution path.

Such machine-readable instructions may also be loaded onto a computer or other programmable data processing devices, so that the computer or other programmable data processing devices perform a series of operations to produce computer-implemented processing. The instructions executed on the computer or other programmable devices thus provide an operation for realizing functions specified by flow(s) in the flow charts and/or block(s) in the block diagrams.

Further, the teachings herein may be implemented in the form of a computer software product. The computer software product is stored in a storage medium and includes a plurality of instructions for making a computer device implement the methods recited in the examples of the present disclosure.

The present inventions may be embodied in other specific apparatus and/or methods. The described embodiments are to be considered in all respects as illustrative and not restrictive. In particular, the scope of the invention is indicated by the appended claims rather than by the description and figures herein. All changes that come within the meaning and range of equivalency of the claims are to be embraced within their scope.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for inferring a program counter of a program executed by a computing system, the method comprising:
identifying, based on a program counter value comprising an address of a sequential instruction in the program, a sequential execution path containing the sequential instruction; and
inferring a further program counter value based on the identified sequential execution path, the further program counter value comprising an address of a last sequential instruction in the identified sequential execution path.

2. The method of claim 1, wherein the sequential execution path is identified based on a decompiled binary of the program.

3. The method of claim 1, wherein the sequential execution path is identified during run-time.

4. The method of claim 1, wherein inferring the further program counter value comprises:
storing an address of the last sequential instruction in the identified sequential execution path; and
determining the further program counter value based on the address of the last sequential instruction in the identified sequential execution path.

5. The method of claim 1, further comprising determining the program counter value based on trace data obtained from the computing system during execution of the program.

6. The method of claim 1, wherein identifying the sequential execution path comprises:
accessing a data cache comprising a mapping of sequential instruction addresses to sequential execution paths; and
applying the mapping to the program counter value, such that the sequential execution path containing the sequential instruction corresponding to the program counter value, is identified.

7. The method of claim 1, further comprising restoring a state of the computing system during program execution based on the program counter.

8. A method for analyzing a decompiled binary of a program, the method comprising:
determining, for each instruction in the decompiled binary, whether the respective instruction is a sequential instruction;
when the respective instruction is a sequential instruction, adding an address of the respective instruction to a list of addresses of sequential instructions;
determining whether the list of addresses comprises at least three addresses; and
storing the list in a data cache of sequential execution paths when the list of addresses comprises at least three addresses.

9. The method of claim 8, further comprising when the respective instruction is a non-sequential instruction, determining whether the respective instruction is a branch instruction, an inferable jump instruction, or a sequentially inferable jump instruction.

10. The method of claim 9, further comprising when the respective instruction is a branch instruction, adding a branch label address to a further list,
wherein the further list comprises addresses of initial instructions of potential sequential execution paths.

11. The method of claim 10, further comprising when the respective instruction is an inferable jump instruction or a sequentially inferable jump instruction, adding a jump address to the further list.

12. The method of claim 11, further comprising for each of the potential sequential execution paths in the further list:
identifying a start address of the respective potential sequential execution path from an ordered list of instructions from the decompiled binary; and
determining whether the respective potential sequential execution path comprises at least three sequential instructions.

13. An apparatus for monitoring a program flow of a program executed by a computing system, the apparatus comprising:
a processor configured to:
identify, based on a program counter value comprising an address of a sequential instruction in the program, a sequential execution path containing the sequential instruction; and
infer a further program counter value based on the identified sequential execution path, the further program counter value corresponding to an address of a last sequential instruction in the identified sequential execution path.

14. The apparatus of claim 13, further comprising a data cache configured to store a mapping of sequential instruction addresses to sequential execution paths.

15. The apparatus of claim 14, wherein the processor being configured to identify the sequential execution path comprises the processor being configured to:
access the data cache; and
apply the mapping to the program counter value, such that the sequential execution path containing the instruction is identified.
